(19) United States
(12) Patent Application Publication
(10) Pub. No.: US 2002/0158873 A1
(43) Pub. Date: Oct. 31, 2002

(54) Real-time virtual viewpoint in simulated reality environment

(76) Inventor: Todd Williamson, Philadelphia, PA (US)

Correspondence Address: Wen Liu, LIU & LIU LLP, Suite 1100, 811 West 7th Street, Los Angeles, CA, 90017, US

(21) Appl. No.: 10/060,008

(22) Filed: Jan. 28, 2002

Related U.S. Application Data
(60) Provisional application No. 60/264,596, filed on Jan. 26, 2001.
(60) Provisional application No. 60/264,604, filed on Jan. 26, 2001.

(51) Int. Cl. G06T 15/10; G06T 15/20

(52) U.S. Cl. 345/427

(57) ABSTRACT

In one aspect of the present invention, the inventive system is capable of inserting video images of human being, animals or other living beings or life forms, and any clothing or objects that they bring with them, into a virtual environment. It is possible for others participating in the environment to see that person as they currently look, in real-time, and from any viewpoint. In another aspect of the present invention, the inventive system that was developed is capable of capturing and saving information about a real object or group of interacting objects (i.e., non-life forms). These objects can then be inserted into a virtual environment at a later time. It is possible for participants in the environment to see the (possibly moving) objects from any viewpoint, exactly as they would appear in real life. Since the system is completely modular, multiple objects can be combined to produce a composite scene. The object can be a human being performing some rote action if desired. These rote actions can be combined.

This is a continuation-in-part application of U.S. Provisional Patent Application No. 60/264,604, filed Jan. 26, 2001, and U.S. Provisional Patent Application No. 60/264,596, filed Jan. 26, 2001.

### BACKGROUND OF THE INVENTION

1. Field of the Invention

This invention relates generally to virtual reality and augmented reality, particularly to real-time simulation of viewpoints of an observer for an animated or unanimated object that has been inserted in a computer depicted simulated reality environment.

2. Description of Related Art

Virtual Reality (VR) is an artificial environment constructed by a computer that permits the user to interact with that environment as if the user were actually immersed in the environment. VR devices permit the user to see three-dimensional (3D) depictions of an artificial environment and to move within that environment. VR broadly includes Augmented Reality (AR) technology, which allows a person to see or otherwise sense a computer-generated virtual world integrated with the real world. The “real world” is the environment that an observer can see, feel, hear, taste, or smell using the observer's own senses. The “virtual world” is defined as a generated environment stored in a storage medium or calculated using a processor. There are a number of situations in which it would be advantageous to superimpose computer-generated information on a scene being viewed by a human viewer. For example, a mechanic working on a complex piece of equipment would benefit by having the relevant portion of the maintenance manual displayed within her field of view while she is looking at the equipment. Display systems that provide this feature are often referred to as “Augmented Reality” systems. Typically, these systems utilize a head-mounted display that allows the user's view of the real world to be enhanced or added to by “projecting” into it computer generated annotations or objects.

In several markets, there is an untapped need for the ability to insert human participants or highly realistic static or moving objects into a real world or virtual world environment in real-time. These markets include military training, computer games, and many other applications of VR, including AR. There are many systems in existence for producing texture-mapped 3D models of objects, particularly for e-commerce applications. They include methods using hand-built or CAD models, and a variety of methods that use 3D sensing technology. The current state-of-the-art systems for inserting objects have many disadvantages, including:

(a) Slow data acquisition time (models are built by hand or use slow automated systems);

(b) Inability to handle motion effectively (most systems only handle still or limited motion);

(c) Lack of realism (most systems have a “plastic” look or limits on the level of detail); and

(d) Limited size of the object to be captured.

Systems currently in use to insert humans into virtual environment include motion capture systems used by video game companies and movie studios, and some advanced research being done by the U.S. Army STRICOM. The current state-of-the-art systems for inserting humans have many other disadvantages, including:

(a) most require some sort of marker or special suit be worn;

(b) Most give a coarse representation of the human in the simulated environment; and

(c) Few systems actually work in real-time; the ones that do are necessarily limited.

None of the prior art systems is capable of inserting static and dynamic objects, and humans and other living beings into a virtual environment, which allows a user to see the object or human as they currently look, in real-time, and from any viewpoint.

### SUMMARY OF THE INVENTION

The present invention is directed to a virtual reality system and underlying structure and architecture, which overcome the drawbacks in the prior art. (The system will sometimes be referred to as the Virtual Viewpoint system herein-below.) In one aspect of the present invention, the inventive system is capable of inserting video images of human being, animals or other living beings or life forms, and any clothing or objects that they bring with them, into a virtual environment. It is possible for others participating in the environment to see that person as they currently look, in real-time, and from any viewpoint. In another aspect of the present invention, the inventive system that was developed is capable of capturing and saving information about a real object or group of interacting objects (i.e., non-life forms). These objects can then be inserted into a virtual environment at a later time. It is possible for participants in the environment to see the (possibly moving) objects from any viewpoint, exactly as they would appear in real life. Since the system is completely modular, multiple objects can be combined to produce a composite scene. The object can be a human being performing some rote action if desired. These rote actions can be combined.

The present invention will be described in reference to human beings or the like as an example of a life form. Hereinafter, any discussion in reference to human, person, or the like does not preclude other life forms such as animals. Further, many of the discussions hereinafter of the underlying inventive concept are equally applicable to human beings (or the like) and objects within context. References and examples discussed in relation to objects could equally apply to humans, and vice versa. Accordingly, such discussions of one do not preclude applicability of the technology to the other, within the scope of spirit of the present invention. Life forms and objects may be referred collectively as “subjects” in the present disclosure.

The underlying concept of the inventive system is that a number of cameras are arrayed around the object to be captured or the human who is to enter the virtual environment. The 3D structure of the object or the person is quickly determined in real time especially for a moving object or person. In order to view the object or human from an arbitrary viewpoint (where a camera may not have been in the real world), the system uses this 3D information and the images that it does have to produce a simulated picture of what the object or human would look like from that viewpoint.

The Virtual Viewpoint system generally comprises the following components and functions: (a) spatially arranged multi-video cameras; (b) digital capture of images; (c) camera calibration; (d) 3D modeling in real-time; (e) encoding and transformation of 3D model and images; (f) compute virtual views for each viewer; (g) incorporate virtual image into virtual space.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is a schematic block diagram illustrating the system architecture of the Virtual Viewpoint system in accordance with one embodiment of the present invention.

FIG. 2 is a flow diagram illustrating the components, functions and processes of the Virtual Viewpoint system in accordance with one embodiment of the present invention.

FIG. 3 is a diagram illustrating the relative viewpoints of real cameras and virtual camera in the view generation process.

FIG. 4 is a diagram illustrating the relative viewpoints of real cameras and virtual camera to resolve an occlusion problem.

FIG. 5 is diagram illustrating the remote collaboration concept of the present invention.

FIG. 6 is a diagram illustrating the user interface and the application of Virtual Viewpoint concept in video-conferencing in accordance with one embodiment of the present invention.

FIG. 7 is a diagram illustrating marker detection and pose estimation.

FIG. 8 is a diagram illustrating virtual viewpoint generation by shape from silhouette.

FIG. 9 is a diagram illustrating the difference between the visual hull and the actual 3-D shape.

FIG. 10 is a diagram illustrating the system diagram of a videoconferencing system incorporating the Virtual Viewpoint concept of the present invention.

FIG. 11 is a diagram illustrating a desktop 3-D augmented reality video-conferencing session.

FIG. 12 is a diagram illustrating several frames from a sequence in which the observer explores a virtual art gallery with a collaborator, which is generated by a system that incorporates the Virtual Viewpoint concept of the present invention.

FIG. 13 is a diagram illustrating a tangible interaction sequence, demonstrating interaction between a user in augmented reality and collaborator in augmented reality, incorporating the Virtual Viewpoint concept of the present invention.

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

All publications referenced herein are fully incorporated by reference as if fully set forth herein.

The present invention can find utility in a variety of implementations without departing from the scope and spirit of the invention, as will be apparent from an understanding of the principles that underlie the invention. It is understood that the Virtual Viewpoint concept of the present invention may be applied for entertainment, sports, military training, business, computer games, education, research, etc. whether in an information exchange network environment (e.g., videoconferencing) or otherwise.

Information Exchange Network

The detailed descriptions that follow are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals capable of being stored, transferred, combined, compared, and otherwise manipulated.

Useful devices for performing the software implemented operations of the present invention include, but are not limited to, general or specific purpose digital processing and/or computing devices, which devices may be standalone devices or part of a larger system. The devices may be selectively activated or reconfigured by a program, routine and/or a sequence of instructions and/or logic stored in the devices. In short, use of the methods described and suggested herein is not limited to a particular processing configuration.

The Virtual Viewpoint platform in accordance with the present invention may involve, without limitation, standalone computing systems, distributed information exchange networks, such as public and private computer networks (e.g., Internet, Intranet, WAN, LAN, etc.), value-added networks, communications networks (e.g., wired or wireless networks), broadcast networks, and a homogeneous or heterogeneous combination of such networks. As will be appreciated by those skilled in the art, the networks include both hardware and software and can be viewed as either, or both, according to which description is most helpful for a particular purpose. For example, the network can be described as a set of hardware nodes that can be interconnected by a communications facility, or alternatively, as the communications facility, or alternatively, as the communications facility itself with or without the nodes. It will be further appreciated that the line between hardware and software is not always sharp, it being understood by those skilled in the art that such networks and communications facility involve both software and hardware aspects.

The Internet is an example of an information exchange network including a computer network in which the present invention may be implemented. Many servers are connected to many clients via Internet network, which comprises a large number of connected information networks that act as a coordinated whole. Various hardware and software components comprising the Internet network include servers, routers, gateways, etc., as they are well known in the art. Further, it is understood that access to the Internet by the servers and clients may be via suitable transmission medium, such as coaxial cable, telephone wire, wireless RF links, or the like. Communication between the servers and the clients takes place by means of an established protocol. As will be noted below, the Virtual Viewpoint system of the present invention may be configured in or as one of the servers, which may be accessed by users via clients.

Overall System Design

The Virtual Viewpoint System puts participants into real-time virtual reality distributed simulations without using body markers, identifiers or special apparel of any kind. Virtual Viewpoint puts the participant's whole body into the simulation, including their facial features, gestures, movement, clothing and any accessories. The Virtual Viewpoint system allows soldiers, co-workers or colleagues to train together, work together or collaborate face-to-face, regardless of each person's actual location.

Virtual Viewpoint is not a computer graphics animation but a live video recording of the full 3D shape, texture, color and sound of moving real-world objects. Virtual Viewpoint can create 3D interactive videos and content, allowing viewers to enter the scene and choose any viewpoint, as if the viewers are in the scene themselves. Every viewer is his or her own cameraperson with an infinite number of camera angles to choose from. Passive broadcast or video watchers become active scene participants.

Virtual Viewpoint Remote Collaboration consists of a series of simulation booths equipped with multiple cameras observing the participants' actions. The video from these cameras is captured and processed in real-time to produce information about the three-dimensional structure of each participant. From this 3D information, Virtual Viewpoint technology is able to synthesize an infinite number of views from any viewpoint in the space, in real-time and on inexpensive mass-market PC hardware. The geometric models can be exported into new simulation environments. Viewers can interact with this stream of data from any viewpoint, not just the views where the original cameras were placed.

System Architecture and Process

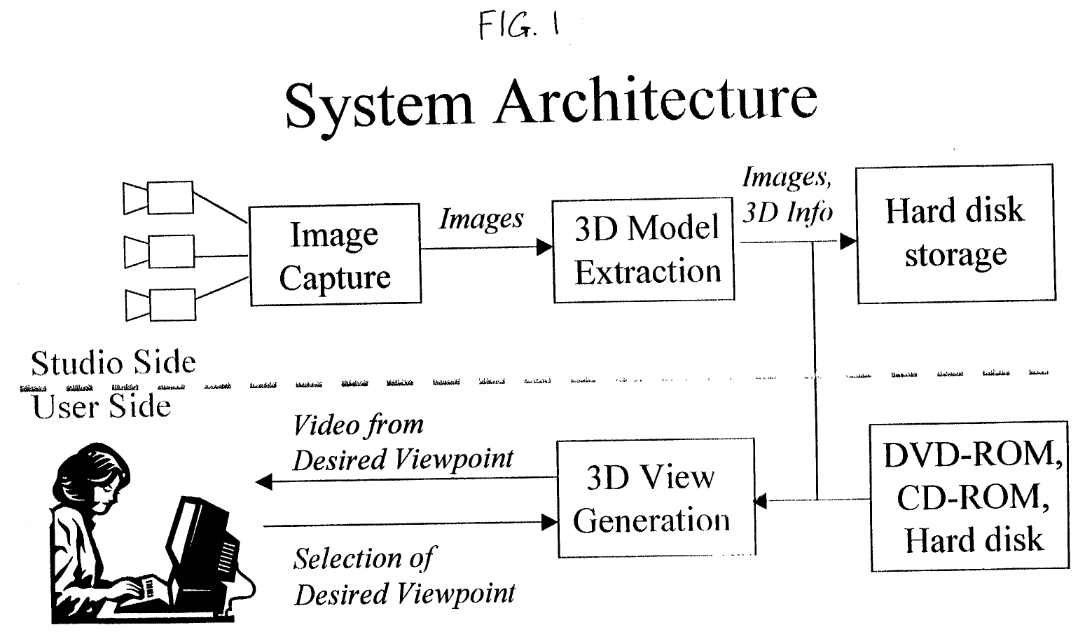

FIG. 1 illustrates the system architecture of the Virtual Viewpoint system based on 3D model generation and image-based rendering techniques to create video from virtual viewpoints. To capture the 3D video image of a subject (human or object), a number of cameras (e.g., 2, 4, 8, 16 or more depending on image quality) is required. Reconstruction from the cameras at one end generates multiple video streams and a 3D model sequence involving 3D model extraction (e.g., based on a “shape from silhouette” technique disclosed below). This information may be stored, and is used to generate novel viewpoints using video-based rendering techniques. The image capture and generation of the 3D model information may be done at a studio side, with the 3D image rendering done at the user side. The 3D model information may be transmitted from the studio to user via a gigabit Ethernet link.

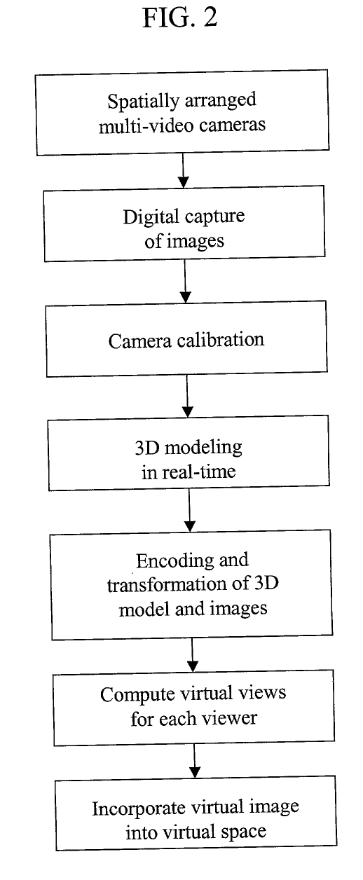

Referring to FIG. 2, the Virtual Viewpoint system generally comprises the following components, process and functions:

(a) A number of cameras arranged around the human or object, looking inward. Practically, this can be as few as 4 cameras or so, with no upper limit other than those imposed by cost, space considerations, and necessary computing power. Image quality improves with additional cameras.

(b) A method for capturing the images digitally, and transferring these digital images to the working memory of a computer.

(c) A method for calibrating the cameras. The camera positions, orientations, and internal parameters such as lens focal length must be known relatively accurately. This establishes a mathematical mapping between 3D points in the world and where they will appear in the images from the cameras. Poor calibration will result in degraded image quality of the output virtual images.

(d) A method for determining the 3D structure of the human form or object in real-time. Any of a number of methods can be used. In order to control the cost of the systems, several methods have been developed which make use of the images from the cameras in order to determine 3D structure. Other options might include special-purpose range scanning devices, or a method called structured light. Embodiments of methods adopted by the present invention are described in more detail below.

(e) A method for encoding this 3D structure, along with the images, and translating it into a form that can be used in the virtual environment. This may include compression in order to handle the large amounts of data involved, and network protocols and interface work to insert the data into the system.

(f) Depending on the encoding chosen, software module may be necessary to compute the virtual views of the human or object for each entity in the system that needs to see such a viewpoint.

(g) Further processing may be required to incorporate the resulting virtual image of the human or object into the view of the rest of the virtual space.

3D Model Generation

In order for this system to work effectively, a method is needed for determining the 3D structure of a person or an arbitrary object. There are a variety of methods that can be used to accomplish this, including many that are available as commercial products. Generally, stereo vision techniques were found to be too slow and lacked the robustness necessary to make a commercial product.

In order to solve these two problems, a technique called “shape from silhouette” or, alternatively, “visual hull construction” is developed . There are at least three different methods of extracting the shape from silhouettes:

(a) Using the silhouettes themselves as a 3D model: This technique is described hereinbelow, which is an improvement over the concept developed at the MIT Graphics Laboratory (MIT Graphics Lab website: http://graphics.lcs.mit.edu/˜wojciech/vh/).

(b) Using voxels to model the shape: This technique has been fully implemented, and reported by Zaxel Systems, Inc., the assignee of the present invention, in the report entitled Voxel-Based Immersive Environments (May 31, 2000) (Final Report to Project Sponsored by Defense Advanced Research Projects Agency (DOD) (ISO) ARPA Order D611/70; Issued by U.S. Army Aviation and Missile Command Under Contract No. DAAH01-00-C-R058 -unclassified, approved for public release/unlimited distribution; which document is fully incorporated by reference herein, as if fully set forth herein. The inventive concepts disclosed therein have been applied for in pending patent applications.) The relative large storage requirements under this technique could be partially alleviated by using an octree-based model.

(c) Generating polygonal models directly from silhouettes. This is a rather complicated technique, but it has several advantages, including being well suited for taking advantage of modem graphics hardware. It also is the easiest system to integrate into the simulated environment. Reference is made to similar technique developed at the University of Karlsruhe (Germany) (http://i3 lwww.ira.uka.de/diplomarbeiten/da_martin_loehlein/Reconstruction.html)

Camera Calibration

3D reconstruction and rendering require a mapping between each image and a common 3D coordinate system. The process of estimating this mapping is called camera calibration. Each camera in a multi-camera system must be calibrated, requiring a multi-camera calibration process. The mapping between one camera and the 3D world can be approximated by an 11-parameter camera model, with parameters for camera position (3) and orientation (3), focal length (1), aspect ratio (1), image center (2), and lens distortion (1). Camera calibration estimates these 11 parameters for each camera.

The estimation process itself applies a non-linear minimization technique to the samples of the image-3D mapping. To acquire these samples, an object must be precisely placed in a set of known 3D positions, and then the position of the object in each image must be computed. This process requires a calibration object, a way to precisely position the object in the scene, and a method to fmd the object in each image. For a calibration object, a calibration plane approximately 2.5 meters and by 2.5 meters is designed and built, which can be precisely elevated to 5 different heights. The plane itself has 64 LEDs laid out in an 8×8 grid, 30 cm between each LED. The LEDs are activated one at a time so that any video image of the plane will have a single bright spot in the image. By capturing 64 images from each camera, each LED is imaged once by each camera. By sequencing the LEDs in a known order, software can determine the precise 3D position of the LED. Finally, by elevating the plane to different heights, a set of points in 3 dimensions can be acquired. Once all the images are captured, a custom software system extracts the positions of the LEDs in all the images and then applies the calibration algorithm. The operator can see the accuracy of the camera model, and can compare across cameras. The operator can also remove any LEDs that are not properly detected by the automated system. (The actual mathematical process of using the paired 3D points and 2D image pixels to determine the 11 parameter model is described in: Roger Y. Tsai; “A versatile camera calibration technique for high-accuracy 3D machine vision metrology using off-the-shelf TV cameras and lenses”; IEEE Journal of Robotics and Automation RA-3(4): 323-344, August 1987.

Another camera calibration scheme is discussed below in connection with the embodiment in which the novel Virtual Viewpoint concept is applied to videoconferencing.

Image-based Rendering Using Silhouettes as an Implicit 3D Model

The goal of the algorithm described here is to produce images from arbitrary viewpoints given images from a small number (5-20 or so) of fixed cameras. Doing this in real time will allow for a 3D TV experience, where the viewer can choose the angle from which they view the action.

The technique described here is based on the concept of Image-Based Rendering (IBR) [see for example, E. Chen and L. Williams. View Interpolation for Image Synthesis. SIGGRAPH'93, pp. 279-288, 1993; S. Laveau and O. D. Faugeras. “3-D Scene Representation as a Collection of Images,” In Proc. of 12th IAPR Intl. Conf. on Pattern Recognition, volume 1, pages 689-691, Jerusalem, Israel, October 1994; M. Levoy and P. Hanrahan. Light Field Rendering. SIGGRAPH '96, August 1996; W. R. Mark. “Post-Rendering 3D Image Warping: Visibility, Reconstruction, and Performance for Depth-Image Warping,” Ph.D. Dissertation, University of North Carolina, Apr. 21, 1999. (Also UNC Computer Science Technical Report TR99-022); L. McMillan. “An Image-Based Approach to Three-Dimensional Computer Graphics,” Ph.D. Dissertation, University of North Carolina, April 1997. (Also UNC Computer Science Technical Report TR97-013)]. Over the last few years research into IBR has produced several mature systems [see for example, W. R. Mark. “Post-Rendering 3D Image Warping: Visibility, Reconstruction, and Performance for Depth-Image Warping,” Ph.D. Dissertation, University of North Carolina, Apr. 21, 1999. (Also UNC Computer Science Technical Report TR99-022); L. McMillan. “An Image-Based Approach to Three-Dimensional Computer Graphics,” Ph.D. Dissertation, University of North Carolina, April 1997. (Also UNC Computer Science Technical Report TR97-013)]. The concept behind IBR is that given a 3D model of the geometry of the scene being viewed, and several images of that scene, it is possible to predict what the scene would look like from another viewpoint. Most IBR research to date has dealt with range maps as the basic 3D model data. A range map provides distance at each pixel to the 3D object being observed.

Shape from Silhouette (a.k.a. voxel intersection) methods have long been known to provide reasonably accurate 3D models from images with a minimum amount of computation [see for example, T. H. Hong and M. Schneier, “Describing a Robot's Workspace Using a Sequence of Views from a Moving Camera,” IEEE Transactions on Pattern Analysis and Machine Intelligence, vol. 7, pp. 721-726, 1985]. The idea behind shape from silhouette is to start with the assumption that the entire world is occupied. Each camera placed in the environment has a model of what the background looks like. If a pixel in a given image looks like the background, it is safe to assume that there are no objects in the scene between the camera and the background along the ray for that pixel. In this way the “silhouette” of the object (its 2D shape as seen in front of a known background) is used to supply 3D shape information. Given multiple views and many pixels, one can “carve” away the space represented by the background pixels around the object, leaving a reasonable model of the foreground object, much as a sculptor must carve away stone.

Shape from Silhouette is usually used to generate a voxel model, which is a 3D data structure where space is divided into a 3D grid, and each location in space has a corresponding memory location. The memory locations contain a value indicating whether the corresponding location in space is occupied or empty. Some researchers have used Shape from Silhouette to generate a voxel model, from which they produce a range map that they can use as a basis for IBR. The methods for producing a range map from a voxel model are complex, time-consuming, and inaccurate. The inaccuracy results from the fact that the grid has finite resolution and is aligned with a particular set of coordinate axes. The approach described here is a direct method for computing depth and pixel values for IBR using only the silhouette masks, without generating an intermediate voxel model. This has several advantages, but the most compelling advantage is that the results are more accurate, since the voxel model is only an approximation to the information contained in the silhouettes. Other related approaches include Space Carving, and Voxel Coloring.

Algorithm Concept

3D reconstruction using the voxel intersection method slices away discrete pieces of 3D space that are considered to be unoccupied. When a particular camera sees a background pixel, it is safe to assume that the space between the camera and the background is empty. This space is actually shaped like a rectangular pyramid with its tip at the focus of the camera, extending out until it intersects the background.

The key idea here is that if a particular 3D location in space is seen as unoccupied by any one camera, the point will be considered unoccupied regardless of what the other cameras see at that location.

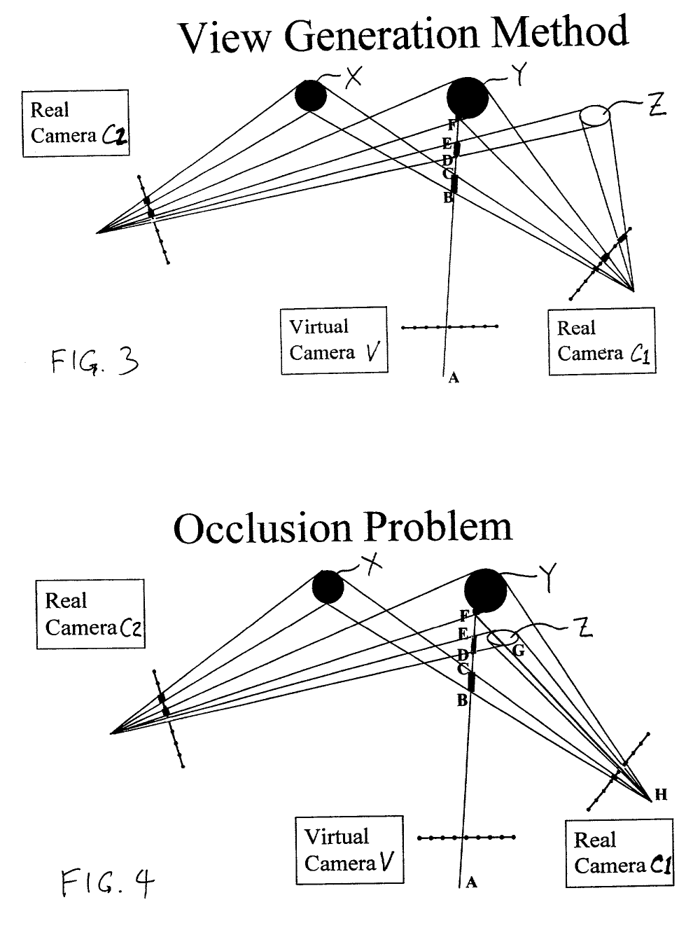

For each pixel in the virtual image, a test point is moved out along the ray corresponding to that pixel, as illustrated in FIG. 3. At each point along the ray, the corresponding pixel in each image is evaluated to see whether the pixel sees the background. In the example of FIG. 3, the example ray is followed outward from the point marked A (the virtual viewpoint or virtual camera V. If any of the cameras sees background at a particular point, that point is considered to be unoccupied, so the next step is to move one step farther out along the ray; this process is repeated. In the example, for each of the points from A to B, no camera considers the points to be occupied. From B to C, the camera C1 on the right sees the object X, but the camera C2 on the left sees nothing. From C to D, again no camera sees anything. From D to E, the camera C2 on the left sees the object Z, but the camera C1 on the right sees nothing. From E to F again neither camera sees anything. Finally, at F, both cameras agree that the point is occupied by the object Y and the search stops.

When a 3D point that all cameras agree is occupied is found, depth of that pixel is found, as well as knowing the position of the point in all of the images. In order to render the pixel, the pixels from the real images are combined.

Algorithm Description

This section contains a high-level description of the algorithm in pseudocode. The subsequent section contains a more detailed version that would be useful to anyone trying to implement the algorithm. This algorithm requires enough information about camera geometry that, given a point in the virtual camera and a distance, where the corresponding point would appear in each of the real cameras can be computed. The only other information needed is the set of silhouette masks from each camera.

for each pixel (x, y) in the virtual camera

distance = 0
searched_cams = {}
while searched_cams != all_cams, choose cam from all_cams − searched_cams

Project the ray for (x,y) in the virtual camera into the image for cam
Let (cx,cy) be the point that is distance along the ray
(ox,oy) = (cx,cy)
while point at (ox,oy) in mask from cam is OCCUPIED

Use line rasterization algorithm to move (ox,oy) outward by one pixel

end
if (ox,oy) = (cx,cy)

searched_cams = searched_cams + {cam}

else

Use (ox,oy) to compute new distance
searched_cams = {}

end

end
distance is the depth of the point (x,y)

end

The usual line rasterization algorithm was developed by Bresenham in 1965, though any algorithm will work. Bresenham's algorithm is discussed in detail Foley's article [see Foley, van Dam, Feiner, and Hughes, “Computer Graphics Principles and Practice,” Second Edition, Addison Wesley, 1990].

Algorithm as Implemented: Depth from Silhouette Mask Images

This description of the algorithm assumes a familiarity with some concepts of computer vision and computer graphics, namely the pinhole camera model and the matrix representation of it using homogeneous coordinates. A good introductory reference to the math can be found in Chapters 5 and 6 of Foley's article [see Foley, van Dam, Feiner, and Hughes, “Computer Graphics Principles and Practice,” Second Edition, Addison Wesley, 1990].

Inputs:

1. Must have known camera calibration in the form of 4×4 projection matrices A_{cam} for each camera. This matrix takes the 3D homogeneous coordinate in space and converts it into an image-centered coordinate. The projection onto the image plane is accomplished by dividing the x and y coordinates by the z coordinate.

2. The virtual camera projection matrix Aᵥᵢᵣₜ

3. The mask images

Outputs:

1. A depth value at each pixel in the virtual camera. This depth value represents the distance from the virtual camera's projection center to the nearest object point along the ray for that pixel.

Algorithm Pseudocode:

For each camera cam, T_{cam}=A_{cam}Aᵥᵢᵣₜ⁻¹

For each pixel (x, y) in the virtual camera

distance = 0
searched_cams = {}
While searched_cams != all_cams, choose cam from all_cams − searched_cams

epipole = (T_{cam}(1,4),T_{cam}(2,4),T_{cam}(3,4))
infinity_point = (T_{cam}(1,1) * X + T_{cam}(1,2) * y + T_{cam}(1,3),

T_{cam}(2,1) * X + T_{cam}(2,2) * y + T_{cam}(2,3),
T_{cam}(3,1) * X + T_{cam}(3,2) * y + T_{cam}(3,3))

close_point = epipole + distance * infinity_point
far_point = infinity_point
cx = close_point(1)/close_point(3)
cy = close_point(2)/close_point(3)
fx = far_point(1)/far_point(3)
fy = far_point(2)/far_point(3)
(clip_cx, clip_cy, clip_fx, clip_fy) = clip_to_image(cx,cy,fx,fy)
(ox,oy) = search_line(mask(cam),clip_cx,clip_cy,clip_fx,clip_fy)
if (ox,oy) = (clip_cx,clip_cy)

searched_cams = searched_cams + {cam}

else

distance = compute_distance(T_{cam},ox,oy)
searched_cams = {}

end

end
depth(x,y) = distance

end

Explanation:

(a) Every pixel in the virtual image corresponds to a ray in space. This ray in space can be seen as a line in each of the real cameras. This line is often referred to as the epipolar line. In homogeneous coordinates, the endpoints of this line are the two variables epipole and infinity_point. Any point between these two points can be found by taking a linear combination of the two homogeneous coordinates.

(b) At any time during the loop, the points along the ray from 0 to distance have been found to be unoccupied. If all cameras agree that the point at distance is occupied, the loop exits and that distance is considered to be the distance at (x, y).

(c) clip_to_image( ) makes sure that the search line is contained entirely within the image by “clipping” the line from (cx, cy) to (fx, fy) so that the endpoints lie within the image coordinates.

(d) search_line( ) walks along the line in mask until a pixel that is marked occupied in the mask is found. It returns this pixel in (ox, oy).

(e) compute_distance( ) simply inverts the equation used to get close_point in order to compute what the distance should be for a given (ox, oy).

(f) As a side effect, the final points (ox, oy) in each camera are actually the pixels that are needed to combine to render the pixel (x, y) in the virtual camera. The following sections will discuss methods for doing this combination.

The Occlusion Problem

Once there is a set of pixels to render in the virtual camera, they are used to select a color for each virtual camera pixel. One of the biggest possible problems is that most of the cameras are not looking at the point to be rendered. For many of the cameras, this is obvious: they are facing in the wrong direction and seeing the backside of the object. But this problem can occur even when cameras are pointing in almost the same direction as the virtual camera, because of occlusion. In this context, occlusion refers to the situation where another object blocks the view of the object that must be rendered. In this case, it is desirable not to use the pixel for the other object when the virtual camera should actually see the object that is behind it.

In order to detect occlusions, the following technique is applied, as shown in FIG. 4. For each camera that is facing in the same direction as the virtual camera V, a depth map is pre-computed using the algorithm described in the previous section. To determine if a pixel from a given camera (C1 and C2) is occluded in the virtual view or not, the computed depth is used in the virtual camera V to transform the virtual pixel into the real camera view. If the depth of the pixel from the virtual view (HF) matches the depth computed for the real view (HG), then the pixel is not occluded and the real camera can be used for rendering. Otherwise pixels from a different camera must be chosen. In other words, if the difference between the depth from the virtual camera (HF) and that from the real camera (HG) is bigger than a threshold, then that real camera cannot be used to render the virtual pixel.

Deriving Information About Object Shape

After computing the 3D position of a particular virtual pixel and determining which cameras can see it based on occlusion, in general there may still be a number of cameras to choose from. These cameras are likely to be observing the surface of the object at a variety of angles. If a camera that sees the surface at a grazing angle is chosen, one pixel from the camera can cover a large patch of the object surface. On the other hand if a camera that sees the surface at close to the surface normal direction is used, each pixel will cover a relatively smaller portion of the object surface. Since the latter case provides for the maximum amount of information about surface detail, it is the preferred alternative.

The last camera that causes a point to move outward along the ray for a given pixel (this is the last camera which causes the variable distance to change in the algorithm) can provide some information about this situation. Since this camera is the one that carves away the last piece of volume from the surface for this pixel, it provides information about the local surface orientation. The best camera direction (the one that is most normal to the surface) should be perpendicular to the direction of the pixel in the mask that defines the surface for the last camera. This provides one constraint on the optimal viewing direction, leaving a two dimensional space of possible optimal camera directions. In order to find another constraint, it is necessary to look at the shape of the mask near the point where the transition from unoccupied to occupied occurred. It is desirable to find a camera that is viewing the edge of the surface that can be seen in the mask in a normal direction. This direction can be computed from the mask. Given this edge direction, it can be decided which cameras are observing the surface from directions that are close to the optimal direction.

More Accurate Object Shape Using Color Constraints

The Shape from Silhouette method has known limitations in that there are shapes that it cannot model accurately, even with an infinite number of cameras [see for example, A Laurentini. How Far 3D Shapes Can Be Understood from 2D Silhouettes. IEEE Transactions on Pattern Analysis and Machine Intelligence, 17(2):188-195, 1995]. This problem is further exacerbated when a small number of cameras are used. For example, the shapes derived from the silhouettes tend to contain straight edges, even when the actual surface is curved.

In order to more accurately model the surface, it is possible to add a color consistency constraint to the algorithm discussed here. The basic idea is that if one has the correct 3D information about the surface being viewed for a particular pixel, then all of the cameras that can see that point should agree on its color. If the cameras report wildly different colors for the point, then something is wrong with the model. After accounting for occlusion and grazing-angle effects, the most likely explanation is that the computed distance to the surface is incorrect. Since the algorithm always chooses the smallest distance to the surface that is consistent with all of the silhouettes, it tends to expand objects outward, toward the camera.

After finding the correct distance to the object using the silhouette method for a given pixel, the example ray is followed outward along the ray for that pixel until the cameras that are able to see the points all agree on a color. The color that they agree upon should be the correct color for the virtual pixel.

To determine the color for virtual pixels, the real cameras closest to the virtual camera are identified, after which each of the cameras is tested for occlusion. Pixels from cameras that pass the occlusion test are averaged together to determine the pixel color.

Advantages

Advantages of the silhouette approach herein include:

1. The silhouettes have about the same size as the voxel model, so similar transmission costs.

2. The depth information can be derived in a computationally efficient manner on the client end.

3. The resulting model is more accurate than a voxel model.

4. Avoids unneeded computation, since only the relevant parts of the 3D model are constructed as they are used.

5. Depth map and rendered image are computed simultaneously.

6. A depth map from the perspective of the virtual camera is generated; this can be used for depth cueing (e.g. inserting simulated objects into the environment).

7. Detection and compensation for object occlusion is handled easily.

Remote Collaboration

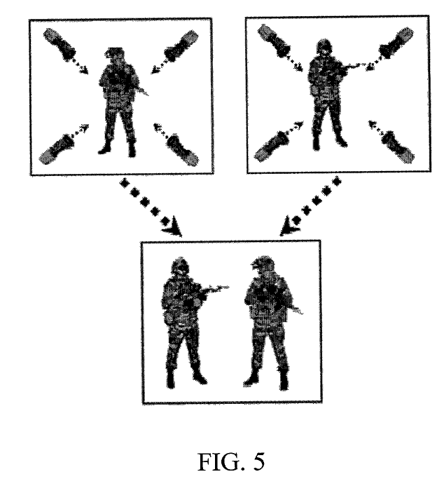

The Virtual Viewpoint™ System puts participants into real-time virtual reality distributed simulations without using body markers, identifiers or special apparel of any kind. Virtual Viewpoint puts the participant's whole body into the simulation, including their facial features, gestures, movement, clothing and any accessories. The Virtual Viewpoint System allows soldiers, co-workers or colleagues to train together, work together or collaborate face-to-face, regardless of each person's actual location. For example, FIG. 5 illustrates the system merging the 3D video image renditions of two soldiers, each originally created by a set of 4 video cameras arranged around the scene.

As an example, using the Virtual Viewpoint technology, a participant in Chicago and a participant in Los Angeles each step off the street and into their own simulation booth, and both are instantly in the same virtual room where they can collaboratively work or train. They can talk to one another, see each other's actual clothing and actions, all in real-time. They can walk around one another, move about in the virtual room and view each other from any angle. Participants enter and experience simulations from any viewpoint and are immersed in the simulation.

Numerous other objects, including real-time, Virtual Viewpoint offline content, even objects from other virtual environments, can be inserted into the scene. The two soldiers can be inserted into an entirely new virtual environment and interact with that environment and each other. This is the most realistic distributed simulation available.

Below is a specific embodiment of the application of the inventive Virtual Viewpoint concept to real-time 3D interaction for augmented and virtual Reality. By way of example and not limitation, the embodiment is described in reference to videoconferencing. This example further illustrates the concepts described above.

Videoconferencing with Virtual Viewpoint

Introduction

A real-time 3-D augmented reality (AR) video-conferencing system is described below in which computer graphics creates what may be the first real-time “holo-phone”. With this technology, the observer sees the real world from his viewpoint, but modified so that the image of a remote collaborator is rendered into the scene. The image of the collaborator is registered with the real world by estimating the 3-D transformation between the camera and a fiducial marker. A novel shape-from-silhouette algorithm, which generates the appropriate view of the collaborator and the associated depth map in real time, is described. This is based on simultaneous measurements from fifteen calibrated cameras that surround the collaborator. The novel view is then superimposed upon the real world and appropriate directional audio is added. The result gives the strong impression that the virtual collaborator is a real part of the scene. The first demonstration of interaction in virtual environments with a “live” fully 3-D collaborator is presented. Finally, interaction between users in the real world and collaborators in a virtual space, using a “tangible” AR interface, is considered.

Existing conferencing technologies have a number of limitations. Audio-only conferencing removes visual cues vital for conversational turn-taking. This leads to increased interruptions and overlap [E. Boyle, A. Anderson and A. Newlands. The effects of visibility on dialogue and performance in a co-operative problem solving task. Language and Speech, 37(1): 1-20, January-March 1994], and difficulty in disambiguating between speakers and in determining willingness to interact [D. Hindus, M. Ackerman, S. Mainwaring and B. Starr. Thunderwire: A field study of an audio-only media space. In Proceedings of CSCW, November 1996]. Conventional 2-D video-conferencing improves matters, but large user movements and gestures cannot be captured [C. Heath and P. Luff. Disembodied Conduct: Communication through video in a multimedia environment. In Proceedings of CHI 91, pages 93-103, ACM Press, 1991], there are no spatial cues between participants [A. Sellen. and B. Buxton. Using Spatial Cues to Improve Videoconferencing. In Proceedings CHI '92, pages 651-652, ACM: May 1992] and participants cannot easily make eye contact [A. Sellen, Remote Conversations: The effects of mediating talk with technology. Human Computer Interaction, 10(4): 401-444, 1995]. Participants can only be viewed in front of a screen and the number of participants is limited by monitor resolution. These limitations disrupt fidelity of communication [S. Whittaker and B. O'Connaill, The Role of Vision in Face-to-Face and Mediated Communication. In Finn, K., Sellen, A., Wilbur, editors, Video-Mediated Communication, pages 23-49. S. Lawerance Erlbaum Associates, New Jersey, 1997] and turn taking [B. O'Conaill, S. Whittaker, and S. Wilbur, Conversations over video conferences: An evaluation of the spoken aspects of video-mediated communication. Human-Computer Interaction, 8: 389-428, 1993], and increase interruptions and overlap [B. O'Conaill, and S. Whittaker, Characterizing, predicting and measuring video-mediated communication: a conversational approach. In K. Finn, A. Sellen, S. Wilbur (Eds.), Video mediated communication. LEA: N.J., 1997]. Collaborative virtual environments restore spatial cues common in face-to-face conversation [S. Benford, and L. Fahlen, A Spatial Model of Interaction in Virtual Environments. In Proceedings of Third European Conference on Computer Supported Cooperative Work (ECSCW'93), Milano, Italy, September 1993], but separate the user from the real world. Moreover, non-verbal communication is hard to convey using conventional avatars, resulting in reduced presence [A. Singer, D. Hindus, L. Stifelman and S. White, Tangible Progress: Less is more in somewire audio spaces. In Proceedings of CHI 99, pages 104-111, May 1999].

Perhaps closest to the goal of perfect tele-presence is the Office of the Future work [R. Raskar, G. Welch, M. Cutts, A. Lake, L. Stesin and H. Fuchs, The Office of the Future: A unified approach to image based modeling and spatially immersive displays. SIGGRAPH 98 Conference Proceedings, Annual Conference Series, pages 179-188, ACM SIGGRAPH, 1998], and the Virtual Video Avatar of Ogi et al. [T. Ogi, T. Yamada, K. Tamagawa, M. Kano and M. Hirose, Immersive Telecommunication Using Stereo Video Avatar. IEEE VR 2001, pages 45-51, IEEE Press, March 2001]. Both use multiple cameras to construct a geometric model of the participant, and then use this model to generate the appropriate view for remote collaborators. Although impressive, these systems only generate a 2.5-D model—one cannot move all the way around the virtual avatar and occlusion problems may prevent transmission. Moreover, since the output of these systems is presented via a stereoscopic projection screen and CAVE respectively, the display is not portable.

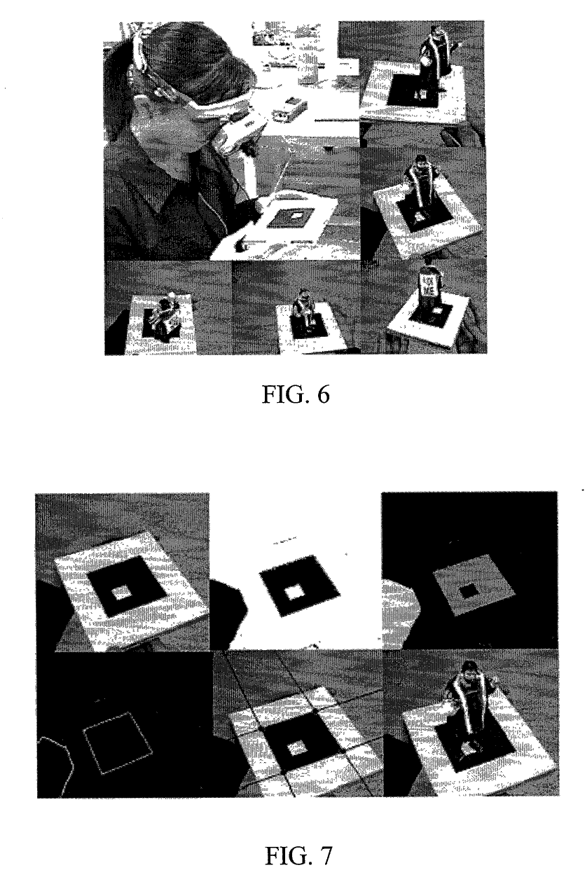

The Virtual Viewpoint technology resolves these problems by developing a 3-D mixed reality video-conferencing system. (See FIG. 6, illustrating how observers view the world via a head-mounted display (HMD) with a front mounted camera. The present system detects markers in the scene and superimposes live video content rendered from the appropriate viewpoint in real time). The enabling technology is a novel algorithm for generating arbitrary novel views of a collaborator at frame rate speeds. These methods are also applied to communication in virtual spaces. The image of the collaborator from the viewpoint of the user is rendered, permitting very natural interaction. Finally, novel ways for users in real space to interact with virtual collaborators is developed, using a tangible user interface metaphor.

System Overview

Augmented reality refers to the real-time insertion of computer-generated three-dimensional content into a real scene (see R. T. Azuma. “A survey of augmented reality.” Presence, 6(4): 355-385, August 1997, and R. Azuma, Y. Baillot, R. Behringer, S. Feiner, S. Julier and B. MacIntyre. Recent Advances in Augmented Reality. IEEE Computer Graphics and Applications, 21(6): 34-37, November/December 2001 for reviews). Typically, the observer views the world through an HMD with a camera attached to the front. The video is captured, modified and relayed to the observer in real time. Early studies, such as S. Feiner, B. MacIntyre, M. Haupt and E. Solomon. Windows on the World: 2D Windows for 3D Augmented Reality. In Proceedings of UIST 93, pages 145-155, Atlanta, Ga., 3-5 November, 1993, superimposed two-dimensional textual information onto real world objects. However, it has now become common to insert three-dimensional objects.

In the present embodiment, live image of a remote collaborator is inserted into the visual scene. (See FIG. 6). As the observer moves his head, this view of the collaborator changes appropriately. This results in the stable percept that the collaborator is three dimensional and present in the space with the observer.

In order to achieve this goal, the following is required for each frame:

(a) The pose of the head-mounted camera relative to the scene is estimated.

(b) The appropriate view of the collaborator is generated.

(c) This view is rendered into the scene, possibly taking account of occlusions.

Each of these problems is considered in turn.

Camera Pose Estimation

The scene was viewed through a Daeyang Cy-Visor DH-4400VP head mounted display (HMD), which presented the same 640×480 pixel image to both eyes. A PremaCam SCM series color security camera was attached to the front of this HMD. This captures 25 images per second at a resolution of 640×480.

The marker tracking method of Kato is employed [H. Kato and M. Billinghurst, Marker tracking and HMD calibration for a video based augmented reality conferencing system, Proc. IWAR 1999, pages 85-94, 1999]. The pose estimation problem is simplified by inserting 2-D square black and white fiducial markers into the scene. Virtual content is associated with each marker. Since both the shape and pattern of these markers is known, it is easy to both locate these markers and calculate their position relative to the camera.

In brief, the camera image is thresholded and contiguous dark areas are identified using a connected components algorithm. A contour seeking technique identifies the outline of these regions. Contours that do not contain exactly four comers are discarded. The comer positions are estimated by fitting straight lines to each edge and determining the points of intersection. A projective transformation is used to map the enclosed region to a standard shape. This is then cross-correlated with stored patterns to establish the identity and orientation of the marker in the image (see FIG. 7, illustrating marker detection and pose estimation; the image is thresholded and connected components are identified; edge pixels are located and comer positions, which determine the orientation of the virtual content, are accurately measured; and region size, number of corners, and template similarity are used to reject other dark areas in the scene). For a calibrated camera, the image positions of the marker corners uniquely identify the three-dimensional position and orientation of the marker in the world. This information is expressed as a Euclidean transformation matrix relating the camera and marker co-ordinate systems, and is used to render the appropriate view of the virtual content into the scene.

It is imperative to obtain precise estimates of the camera parameters. First, the projective camera parameters must be simulated in order to realistically render three-dimensional objects into the scene. Second, any radial distortion must be compensated for when captured video is displayed to the user.

In the absence of radial distortion, straight lines in the world generate straight lines in the image. Hence, straight lines were fitted to the image of a regular 2D grid of points. The distortion parameter space is searched exhaustively to maximize goodness of fit. The center point of the distortion and the second order distortion co-efficient is estimated in this way. The camera perspective projection parameters (focal length and principal point) are estimated using a regular 2-D grid of dots. Given the exact position of each point relative to the grid origin, and the corresponding image position, one can solve for the camera parameters using linear algebra. Software for augmented reality marker tracking and calibration can be downloaded from “http://www.hitl.washington.edu/artoolkit/”.

Model Construction

In order to integrate the virtual collaborator seamlessly into the real world, the appropriate view for each video frame must be generated. One approach is to develop a complete 3D depth reconstruction of the collaborator, from which an arbitrary view can be generated. Depth information could be garnered using stereo-depth. Stereo reconstruction can been achieved at frame rate [T. Kanade, H. Kano, S. Kimura, A. Yoshida and O. Kazuo, “Development of a Video-Rate Stereo Machine.” Proceedings of International Robotics and Systems Conference, pages 95-100, Pittsburgh, Pa., August 1995], but only with the use of specialized hardware. However, the resulting dense depth map is not robust, and no existing system places cameras all round the subject.

A related approach is image-based rendering, which sidesteps depth-reconstruction by warping between several captured images of an object to generate the new view. Seitz and Dyer [S. M. Seitz and C. R. Dyer, View morphing, SIGGRAPH 96 Conference Proceedings, Annual Conference Series, pages 21-30. ACM SIGGRAPH 96, August 1996] presented the first image-morphing scheme that was guaranteed to generate physically correct views, although this was limited to novel views along the camera baseline. Avidan and Shashua [S. Avidan and A. Shashua. Novel View Synthesis by Cascading Trilinear Tensors. IEEE Transactions on Visualization and Computer Graphics, 4(4): 293-305, October-December 1998] presented a more general scheme that allowed arbitrary novel views to be generated from a stereoscopic image pair, based on the calculation of the tri-focal tensor. Although depth is not explicitly computed in these methods, they still require dense matches computation between multiple views and are hence afflicted with the same problems as depth from stereo.

A more attractive approach to fast 3D model construction is shape-from-silhouette. A number of cameras are placed around the subject. Each pixel in each camera is classified as either belonging to the subject (foreground) or the background. The resulting foreground mask is called a “silhouette”. Each pixel in each camera collects light over a (very narrow) rectangular-based pyramid in 3D space, where the vertex of the pyramid is at the focal point of the camera and the pyramid extends infinitely away from this. For background pixels, this space can be assumed to be unoccupied. Shape-from-silhouette algorithms work by initially assuming that space is completely occupied, and using each background pixel from each camera to carve away pieces of the space to leave a representation of the foreground object.

Clearly, the reconstructed model will improve with the addition of more cameras. However, it can be proven that the resulting depth reconstruction may not capture all aspects of the true shape of the object, even given an infinite number of cameras. The reconstructed shape was termed the “visual hull” by Laurentini [A. Laurentini, The Visual Hull Concept for Sillhouette Based Image Understanding. IEEE PAMI, 16(2): 150-162, February 1994], who did the initial work in this area.

Despite these limitations, shape-from-silhouette has three significant advantages over competing technologies. First, it is more robust than stereovision. Even if background pixels are misclassified as part of the object in one image, other silhouettes are likely to carve away the offending misclassified space. Second, it is significantly faster than either stereo, which requires vast computation to calculate cross-correlation, or laser range scanners, which generally have a slow update rate. Third, the technology is inexpensive relative to methods requiring specialized hardware.

Application of Virtual Viewpoint System

For these reasons, the Virtual Viewpoint system in this embodiment is based on shape-from-silhouette information. This is the first system that is capable of capturing 3D models and textures at 30 fps and displaying them from an arbitrary viewpoint.

The described system is an improvement to the work of Matusik et al. [W. Matusik, C. Buehler, R. Raskar, S. J. Gortler and L. McMillan, Image-Based Visual Hulls, SIGGRAPH 00 Conference Proceedings, Annual Conference Series, pages 369-374, 2000] who also presented a view generation algorithm based on shape-from-silhouette. However, the algorithm of the present system is considerably faster. Matusik et al. can generate 320×240 pixel novel views at 15 fps with a 4 camera system, whereas the present system produces 450×340 images at 30 fps, based on 15 cameras. The principal reason for the performance improvement is that our algorithm requires only computation of an image-based depth map from the perspective of the virtual camera, instead of the generating the complete visual hull.

Virtual Viewpoint Algorithm

Given any standard 4×4 projection matrix representing the desired virtual camera, the center of each pixel of the virtual image is associated with a ray in space that starts at the camera center and extends outward. Any given distance along this ray corresponds to a point in 3D space. In order to determine what color to assign to a particular virtual pixel, the first (closest) potentially occupied point along this ray must be known. This 3D point can be projected back into each of the real cameras to obtain samples of the color at that location. These samples are then combined to produce the final virtual pixel color.

Thus the algorithm performs three operations at each virtual pixel:

(a) Determine the depth of the virtual pixel as seen by the virtual camera.

(b) Find corresponding pixels in nearby real images

(c) Determine pixel color based on all these measurements.

(a) Determining Pixel Depth

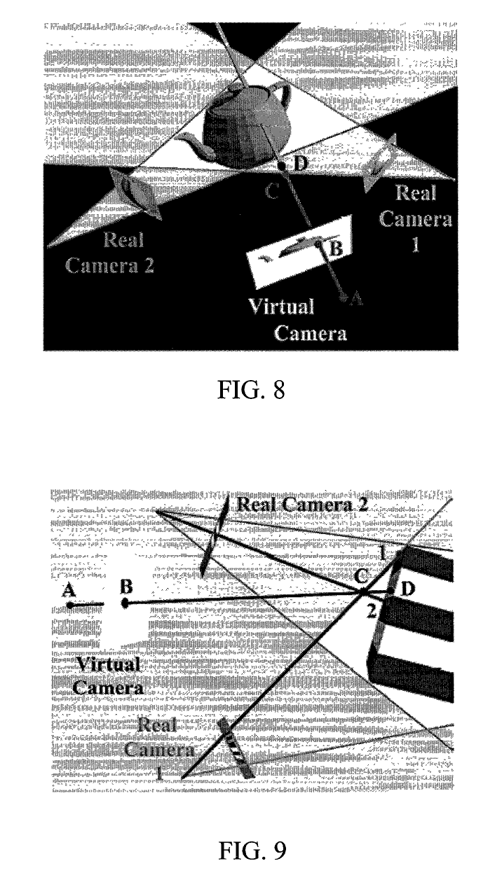

The depth of each virtual pixel is determined by an explicit search. The search starts at the virtual camera projection center and proceeds outward along the ray corresponding to the pixel center. (See FIG. 8, illustrating virtual viewpoint generation by shape from silhouette; points which project into the background in any camera are rejected; the points from A to C have already been processed and project to background in both images, so are marked as unoccupied (magenta); the points yet to be processed are marked in yellow; and point D is in the background in the silhouette from camera 2, so it will be marked as unoccupied and the search will proceed outward along the line.). Each candidate 3D point along this ray is evaluated for potential occupancy. A candidate point is unoccupied if its projection into any of the silhouettes is marked as background. When a point is found for which all of the silhouettes are marked as foreground, the point is considered potentially occupied, and the search stops.

It is assumed that the subject is completely visible in every image. To constrain the search for each virtual pixel, the corresponding ray is intersected with the boundaries of each image. The ray is projected into each real image to form the corresponding epipolar line. The points where these epipolar lines meet the image boundaries are found and these boundary points are projected back onto the ray. The intersections of these regions on the ray define a reduced search space. If the search reaches the furthest limit of this region without finding any potentially occupied pixels, the virtual pixel is marked as background.

The resulting depth is an estimate of the closest point along the ray that is on the surface of the visual hull. However, the visual hull may not accurately represent the shape of the object and hence this 3D point may actually lie outside of the object surface. (See FIG. 8).

(b) Determining Candidate Cameras

Since the recovered 3D positions of points are not exact, care needs to be taken in choosing the cameras from which pixel colors will be combined (See FIG. 9, illustrating the difference between the visual hull and the actual 3-D shape; the point on the visual hull does not correspond to a real surface point, so neither sample from the real cameras is appropriate for virtual camera pixel B; and, in this case, the closer real camera is preferred, since its point of intersection with the object is closer to the correct one.). Depth errors will cause the incorrect pixels to be chosen from each of the real camera views. This invention aims to minimize the visual effect of these errors.

In general it is better to choose incorrect pixels that are physically closest to the simulated pixel. The optimal camera should be the one minimizing the angle between the rays corresponding to the real and virtual pixels. For a fixed depth error, this minimizes the distance between the chosen pixel and the correct pixel. The cameras proximity is ranked once per image, based on the angle between the real and virtual camera axes.

It can now be computed where the virtual pixel lies in each candidate camera's image. Unfortunately, the real camera does not necessarily see this point in space—another object may lie between the real camera and the point. If the real pixel is occluded in this way, it cannot contribute its color to the virtual pixel.

The basic approach is to run the depth search algorithm on a pixel from the real camera. If the recovered depth lies close enough in space to the 3D point computed for the virtual camera pixel, it is assumed the real camera pixel is not occluded—the color of this real pixel is allowed to contribute to the color of the virtual pixel. In practice, system speed is increased by immediately accepting points that are geometrically certain not to be occluded.

(c) Determining Virtual Pixel Color

After determining the depth of a virtual pixel and which cameras have an un-occluded view, all that remains is to combine the colors of real pixels to produce a color for the virtual pixel. The simplest method would be to choose the pixel from the closest camera. However, this produces sharp images that often contain visible borders where adjacent pixels were taken from different cameras. Pixel colors vary between cameras for several reasons. First, the cameras may have slightly different spectral responses. Second, the 3D model is not exact, and therefore the pixels from different cameras may not line up exactly. Third, unless the bidirectional reflectance distribution function is uniform, the actual reflected light will vary at different camera vantage points.

In order to compensate for these effects, the colors of several candidate pixels are averaged together. The simplest and fastest method is to take a straight average of the pixel color from the N closest cameras. This method produces results that contain no visible borders within the image. However, it has the disadvantage that it produces a blurred image even if the virtual camera is exactly positioned at one of the real cameras. Hence, a weighted average is taken of the pixels from the closest N cameras, such that the closest camera is given the most weight. This method produces better results than either of the previous methods, but requires more substantial computation.

System Hardware and Software

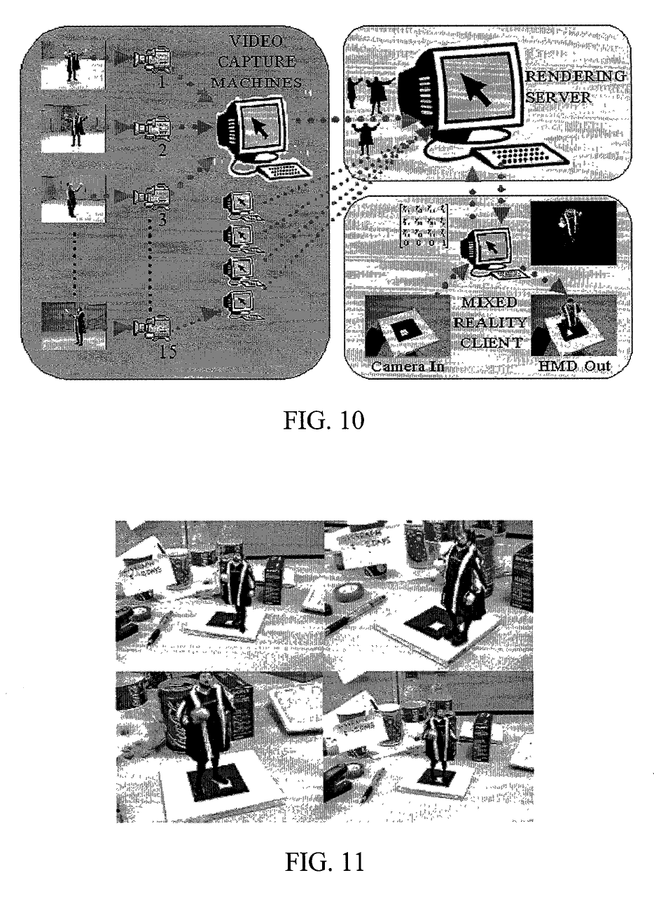

Fourteen Sony DCX-390 video cameras were equally spaced around the subject, and one viewed him/her from above. (See FIG. 10, illustrating the system diagram and explaining that five computers pre-process the image to find the silhouettes and pass the data to the rendering server, the mixed reality machine takes the camera output from the head mounted display and calculates the pose of he marker, and this information is then passed to the rendering server that returns the appropriate image of the subject, which is rendered into the user's view in real time.). Five video-capture machines received data from three cameras each. Each video-capture machine had Dual 1 GHz Pentium III processors and 2 Gb of memory. The video-capture machines pre-process the video frames and pass them to the rendering server via gigabit Ethernet links. The rendering server had a 1.7 GHz Pentium IV Xeon processor and 2 Gb of memory.

Each video-capture machine receives the three 640×480 video-streams in YcrCb format at 30 Hz and performs the following operations on each:

(a) Each pixel is classified as foreground or background by assessing the likelihood that it belongs to a statistical model of the background. This model was previously generated from video-footage of the empty studio.

(b) Morphological operators are applied to remove small regions that do not belong to the silhouette.

(c) Geometric radial lens distortion is corrected for.

Since each foreground object must be completely visible from all cameras, the zoom level of each camera must be adjusted so that it can see the subject, even as he/she moves around. This means that the limited resolution of each camera must be spread over the desired imaging area. Hence, there is a trade-off between image quality and the volume that is captured.

Similarly, the physical space needed for the system is determined by the size of the desired capture area and the field of view of the lenses used. A 2.8 mm lens has been experimented with that provides approximately a 90 degree field of view. With this lens, it is possible to capture a space that is 2.5 m high and 3.3 m in diameter with cameras that are 1.25 meters away.

Calibration of Camera

In order to accurately compute the 3D models, it is necessary to know where a given point in the imaged space would project in each image to within a pixel or less. Both the internal parameters for each camera, and the spatial transformation between the cameras are estimated. This method is based on routines from Intel's OpenCV library. The results of this calibration are optimized using a robust statistical technique (RANSAC).

Calibration data is gathered by presenting a large checkerboard to all of the cameras. For our calibration strategy to be successful, it is necessary to capture many views of the target in a sufficiently large number of different positions. Intel's routines are used to detect all the corners on the checkerboard, in order to calculate both a set of intrinsic parameters for each camera and a set of extrinsic parameters relative to the checkerboard's coordinate system. This is done for each frame where the checkerboard was detected. If two cameras detect the checkerboard in the same frame, the relative transformation between the two cameras can be calculated. By chaining these estimated transforms together across frames, the transform from any camera to any other camera can be derived.

Each time a pair of cameras both see the calibration pattern in a frame, the transformation matrix is calculated between these camera positions. This is considered to be one estimate of the true transform. Given a large number of frames, a large number of these estimates are generated that may differ considerably. It is desired to combine these measurements to attain an improved estimate.

One approach would be to simply take the mean of these estimates, but better results can be obtained by removing outliers before averaging. For each camera pair, a relative transform is chosen at random and a cluster of similar transforms is selected, based on proximity to the randomly selected one. This smaller set is averaged, to provide an improved estimate of the relative transform for that pair of cameras. These stochastically chosen transforms are then used to calculate the relative positions of the complete set of cameras relative to a reference camera.

Since the results of this process are heavily dependent on the initial randomly chosen transform, it is repeated several times to generate a family of calibration sets. The “best” of all these calibration sets is picked. For each camera, the point at which the corners of the checkerboard are detected corresponds to a ray through space. With perfect calibration, all the rays describing the same checkerboard comer will intersect at a single point in space. In practice, calibration errors mean that the rays never quite intersect. The “best” calibration set is defined to be the set for which these rays most nearly intersect.

3-D INTERACTION FOR AR AND VR

The fall system combines the virtual viewpoint and augmented reality software (see FIG. 10). For each frame, the augmented reality system identifies the transformation matrix relating marker and camera positions. This is passed to the virtual viewpoint server, together with the estimated camera calibration matrix. The server responds by returning a 374×288 pixel, 24 bit color image, and a range estimate associated with each pixel. This simulated view of the remote collaborator is then superimposed on the original image and displayed to the user.

In order to support the transmission of a full 24 bit color 374×288 image and 16 bit range map on each frame, a gigabit Ethernet link is used. The virtual view renderer operated at 30 frames per second at this resolution on average. Rendering speed scales linearly with the number of pixels in the image, so it is quite possible to render slightly smaller images at frame rate. Rendering speed scales sub-linearly with the number of cameras, and image quality could be improved by adding more.

The augmented reality software runs comfortably at frame rate on a 1.3 GHz PC with an nVidia GeForce II GLX video card. In order to increase the system speed, a single frame delay is introduced into the presentation of the augmented reality video. Hence, the augmented reality system starts processing the next frame while the virtual view server generates the view for the previous one. A swap then occurs. The graphics are returned to the augmented reality system for display, and the new transformation matrix is sent to the virtual view renderer. The delay ensures that neither machine wastes significant processing time waiting for the other and a high throughput is maintained.

Augmented Reality Conferencing

A desktop video-conferencing application is now described. This application develops the work of Billinghurst and Kato [M. Billinghurst and H. Kato, Real World Teleconferencing, In Proceedings of CHI'99 Conference Companion ACM, New York, 1999], who associated two-dimensional video-streams with fiducial markers. Observers could manipulate these markers to vary the position of the video streams and restore spatial cues. This created a higher feeling of remote presence in users.

In the present system, participant one (the collaborator) stands surrounded by the virtual viewpoint cameras. Participant two (the observer) sits elsewhere, wearing the HMD. The terms “collaborator” and “observer” are used in the rest of the description herein to refer to these roles. Using the present system, a sequence of rendered views of the collaborator is sent to the observer so that the collaborator appears superimposed upon a fiducial marker in the real world. The particular image of the collaborator generated depends on the exact geometry between the HMD-mounted camera and the fiducial marker. Hence, if the observer moves his head, or manipulates the fiducial marker, the image changes appropriately. This system creates the perception of the collaborator being in the three-dimensional space with the observer. The audio stream generated by the collaborator is also spatialized so that it appears to emanate from the virtual collaborator on the marker.

For the present application, a relatively large imaging space (approx 3×3×2 m) has been chosen, which is described at a relatively low resolution. This allows the system to capture movement and non-verbal information from gestures that could not possibly be captured with a single fixed camera. The example of an actor auditioning for a play is presented. (See FIG. 11, a desktop 3-D augmented reality video-conferencing, which captures full body movement over a 3 m×3 m area allowing the expression of non-verbal communication cues.). The full range of his movements can be captured by the system and relayed into the augmented space of the observer. Subjects reported the feeling that the collaborator was a stable and real part of the world. They found communication natural and required few instructions.

Collaboration in Virtual Environments

Virtual environments represent an exciting new medium for computer-mediated collaboration. Indeed, for certain tasks, they are demonstrably superior to video-conferencing [M. Slater, J. Howell, A. Steed, D-P. Pertaub, M. Garau, S. Springel . Acting in Virtual Reality. ACM Collaborative Virtual Environments, pages 103-110, 2000]. However, it was not previously possible to accurately visualize collaborators within the environment and a symbolic graphical representation (avatar) was used in their place. Considerable research effort has been invested in identifying those non-verbal behaviors that are crucial for collaboration [J. Cassell and K. R. Thorisson. The power of a nod and a glance: Envelope vs. emotional feedback in animated conversational agents. Applied Artificial Intelligence, 13 (4-5): 519-539, June 1999] and elaborate interfaces have been developed to control expression in avatars.

In this section, the symbolic avatar is replaced with a simulated view of the actual person as they explore the virtual space in real time. The appropriate view of a collaborator in the virtual space is generated, as seen from our current position and orientation.

In order to immerse each user in the virtual environment, it is necessary to precisely track their head orientation and position, so that the virtual scene can be rendered from the correct viewpoint. These parameters were estimated using the Intersense IS900 tracking system. This is capable of measuring position to within 1.5 mm and orientation to within 0.05 degree inside a 9×3 m region at video frame rates. For the observer, the position and orientation information generated by the Intersense system is also sent to the virtual view system to generate the image of the collaborator and the associated depth map. This is then written into the observer's view of the scene. The depth map allows occlusion effects to be implemented using Z-buffer techniques.

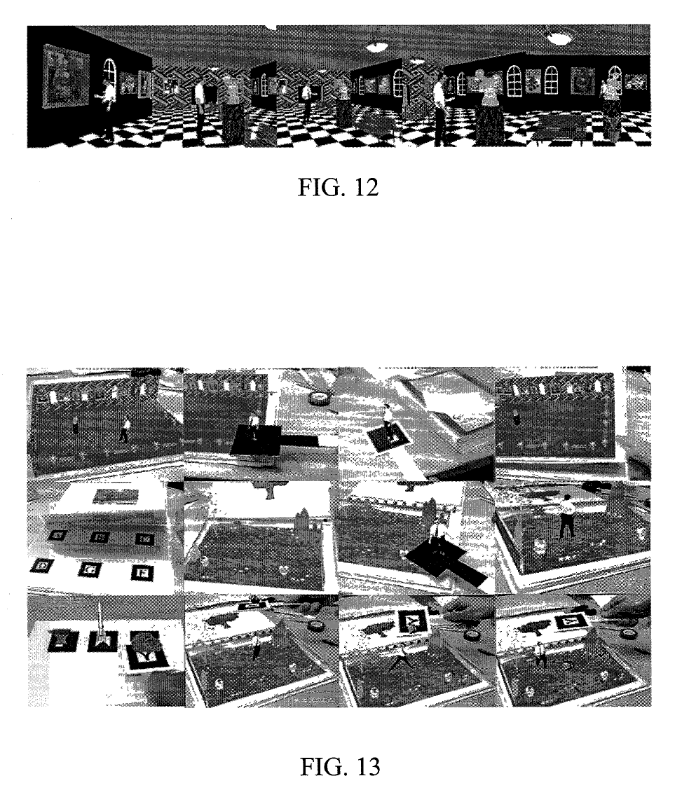

FIG. 12 shows several frames from a sequence in which the observer explores a virtual art gallery with a collaborator, who is an art expert. (FIG. 12 illustrating interaction in virtual environments. The virtual viewpoint generation can be used to make live video avatars for virtual environments. The example of a guide in a virtual art gallery is presented. The subject can gesture to objects in the environment and communicate information by non-verbal cues. The final frame shows how the depth estimates generated by the rendering system can be used to generate correct occlusion. Note that in this case the images are rendered 640×480 pixel resolution at 30 fps.). The collaborator, who is in the virtual view system, is seen to move through the gallery discussing the pictures with the user. The virtual viewpoint generation captures the movement and gestures of the art expert allowing him to gesture to features in the virtual environment and communicate naturally. This is believed to be the first demonstration of collaboration in a virtual environment with a live, fully three-dimensional video avatar.

Tangible AR Interaction

One interesting aspect of the video-conferencing application was that the virtual content was attached to physical real-world objects. Manipulation of such objects creates a “tangible user interface” with the computer (see FIG. 6). In our previous application, this merely allowed the user to position the video-conferencing stream within his/her environment. These techniques can also be applied to interact with the user in a natural physical manner. For example, Kato et al. [H. Kato, M. Billinghurst, I. Poupyrev, K. Inamoto and K. Tachibana, Virtual Object Manipulation on a table-top AR environment. Proceedings of International Symposium on Augmented Reality, 2000] demonstrated a prototype interior design application in which users can pick up, put down, and push virtual furniture around in a virtual room. Other examples of these techniques are presented in I. Poupyrev, D. Tan, M. Billinghurst, H. Kato and H. Regenbrecht. Tiles: A mixed reality authoring interface. Proceedings of Interact 2001, 2001, M. Billinghurst, I. Poupyrev, H. Kato and R. May. Mixing realities in shared space: An augmented reality interface for collaborative computing. IEEE International Conference on Multimedia and Expo, New York, July 2000 and M. Billinghurst, I. Poupyrev, H. Kato and R. May, Mixing realities in shared space: An augmented reality interface for collaborative computing, IEEE International Conference on Multimedia and Expo, New York, July 2000. The use of tangible AR interaction techniques in a collaborative entertainment application has been explored. The observer views a miniaturized version of a collaborator exploring the virtual environment, superimposed upon his desk in the real world. FIG. 13 illustrates a tangible interaction sequence, demonstrating interaction between a user in AR and collaborator in AR. The sequence runs along each row in turn. In the first frame, the user sees the collaborator exploring a virtual environment on his desktop. The collaborator is associated with a fiducial marker “paddle”. This forms a tangible interface that allows the user to take him out of the environment. The user then changes the page in a book to reveal a new set of markers and VR environment. This is a second example of tangible interaction. He then moves the collaborator to the new virtual environment, which can now be explored. In the final row, an interactive game is represented. The user selects a heavy rock from a “virtual arsenal” using the paddle. He then moves it over the collaborator and attempts to drop it on him. The collaborator sees the rock overhead and attempts to jump out of the way. The observer is associated with a virtual “paddle.” The observer can now move the collaborator around the virtual environment, or even pick him up and place him inside a new virtual environment by manipulating the paddle. After M. Billinghurst, H. Kato and I. Poupyrev. The MagicBook: An interface that moves seamlessly between reality and virtuality. IEEE Computer Graphics and Applications, 21(3): 6-8, May/June 2001, the particular virtual environment is chosen using a real-world book as the interface. A different fiducial marker (or set thereof) is printed on each page and associated with a different environment. The observer simply turns the pages of this book to choose a suitable virtual world.

Similar techniques can be employed to physically interact with the collaborator. The example of a “cartoon” style environment is presented in FIG. 13. The paddle is used to drop cartoon objects such as anvils and bombs onto the collaborator, who attempts, in real time, to jump out of the way. The range map of the virtual view system allows us to calculate the mean position of the observer and hence implement a collision detection routine.

The observer picks up the objects from a repository by placing the paddle next to the object. He drops the object by tilting the paddle when it is above the observer. This type of collaboration between an observer in the real world and a colleague in a virtual environment is important and has not previously been explored.

Result

A novel shape-from-silhouette algorithm has been presented, which is capable of generating a novel view of a live subject in real time, together with the depth map associated with that view. This represents a large performance increase relative to other published work. The volume of the captured region can also be expanded by relaxing the assumption that the subject is seen in all of the cameras views.

The efficiency of the current algorithm permits the development of a series of live collaborative applications. An augmented reality based video-conferencing system is demonstrated in which the image of the collaborator is superimposed upon a three-dimensional marker in the real world. To the user the collaborator appears to be present within the scene. This is the first example of the presentation of live, 3D content in augmented reality. Moreover, the system solves several problems that have limited previous video-conferencing applications, such as natural non-verbal communication.

The virtual viewpoint system is also used to generate a live 3D avatar for collaborative work in a virtual environment. This is an example of augmented virtuality in which real content is introduced into virtual environments. As before, the observer always sees the appropriate view of the collaborator but this time they are both within a virtual space. The large area over which the collaborator can be imaged allows movement within this virtual space and the use of gestures to refer to aspects of the world.

Lastly, “tangible” interaction techniques is used to show how a user can interact naturally with a collaborator in a three-dimensional world. The example of a game whereby the collaborator must dodge falling objects dropped by the user is presented. A real world use could be an interior design application, where a designer manipulated the contents of a virtual environment, even while the client stood inside the world. This type of collaborative interface is as a variant of Ishii's tangible user interface metaphor [H. Ishii and B. Ulmer, Tangible bits: towards seamless interfaces between people, bits and atoms, In Proceedings of CHI 97. Atlanta, Ga., USA, 1997].

The process and system of the present invention has been described above in terms of functional modules in block diagram format. It is understood that unless otherwise stated to the contrary herein, one or more functions may be integrated in a single physical device or a software module in a software product, or one or more functions may be implemented in separate physical devices or software modules at a single location or distributed over a network, without departing from the scope and spirit of the present invention.

It is appreciated that detailed discussion of the actual implementation of each module is not necessary for an enabling understanding of the invention . The actual implementation is well within the routine skill of a programmer and system engineer, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

1. A method of rendering video images of a subject at virtual viewpoint in a simulated reality environment, comprising the steps of:
(a) arranging a plurality of video cameras at different views about the subject;
(b) digitally capturing video images of the subject at the different views;
(c) modeling 3D video image of the subject in real-time;
(d) computing virtual images for a viewer at different viewpoints;
(g) incorporating the virtual images into the simulated reality environment in accordance with viewer's viewpoint.
